(19) United States
(12) Patent Application Publication
(10) Pub. No.: US 2011/0105289 A1
(43) Pub. Date: May 5, 2011

(54) METHOD OF DETERMINING THE REFERENCE LATERAL POSITION OF A COPY IN A FOLDING MACHINE, CORRESPONDING METHOD OF USING A FOLDING MACHINE AND CORRESPONDING FOLDING MACHINE

(75) Inventor: Raphael Kegelin, Strasbourg (FR)

(73) Assignee: Goss International Montataire SA, Montataire (FR)

(21) Appl. No.: 12/936,335

(22) PCT Filed: Apr. 2, 2009
(86) PCT No.: PCT/FR09/50566

§ 371 Date: Dec. 28, 2010

(30) Foreign Application Priority Data
Apr. 4, 2008 (FR) 0852268

(51) Int. Cl. B31B 1/00

(52) U.S. Cl. 493/37

(57) ABSTRACT

A method is provided for determining a reference lateral position of a copy in a folding machine, the copy having a given width and being defined by first and second lateral edges, the folding machine being designed to convey the copy in a path and having at least two conveying members that convey the copy over a first portion of the path, each first conveying member defining, for each of the first and second lateral edges, a first preferred lateral zone. At least one of the first preferred lateral zones extends laterally outside the first connected conveying member and laterally overlaps said first conveying member. The reference lateral position is determined such that at least the first lateral edge is situated inside a first preferred lateral zone associated with said first lateral edge. The method may be applied to offset rotary presses.

The present invention concerns a method for determining a reference lateral position of a copy in a folding machine.

### BACKGROUND

Known from document EP-A-658 426 is a method used to determine the lateral position of a copy in a folding machine such that when the fingers of a collecting cylinder grip the front edge of the copy, it is not damaged. The lateral position of the copy is determined such that the lateral edges are at least half covered with a conveyor belt.

However, a folding machine has a number of conveying devices arranged behind each other in the folding machine and serving to convey the copy through the folding machine. These conveying devices are, for example, made up of conveyor belts. The conveyor belts from one conveying device to another are not arranged in the same lateral position. As a result, a given lateral position of a copy can lead to optimal positioning in relation to the belts of a first conveying device, but positioning damaging the lateral edges in a second conveying device.

### SUMMARY OF THE INVENTION

The present invention provides a method making it possible to minimize the danger of damaging a copy in a folding machine, through several conveying devices and according to various types of damage. The damaging conditions being minimized, the benefit will may be felt in terms of waste and/or the maximum production rhythm if they depend on it.

To that end, the invention provides a method as indicated above, characterized in that at least one of the first preferred lateral zones extends laterally beyond the first connected conveying member and laterally overlaps said first conveying member, and in that the reference lateral position is determined such that at least the first lateral edge is situated inside a first preferred lateral zone associated with said first lateral edge.

According to specific embodiments, the method according to the invention may include one or several of the following features:
the reference lateral position is determined such that the second lateral edge is situated inside a first preferred lateral zone connected to said second lateral edge;
the or each first preferred lateral zone is defined by a maximum lateral cantilever of the concerned lateral edge in relation to the first related conveying member;
a positioning quality value Q is calculated for at least two lateral positions of the copy in the folding machine, the positioning quality value Q indicates the risk of damage to the copy, the positioning quality value Q depends on the position of the first and second lateral edges in relation to the preferred lateral zones, and the reference lateral position is that whereof the quality value Q corresponds to the smallest risk of damage among the calculated positioning quality values Q;
the positioning quality value Q is a function of a first cantilever coefficient CPAF1j that is a function of the cantilever of at least one of the lateral edges in relation to the first related conveying member;
the first cantilever coefficient CPAF1j is determined by a function that is monotonous inside the first related preferred lateral zone, and a first penalty modulator is added to the first cantilever coefficient CPAF1j when the concerned lateral edge is situated outside this preferred lateral zone;
the folding machine includes at least two conveying members for conveying the copy onto a second portion of the path, each second conveying member defines, for each of the lateral edges, a second preferred lateral zone, at least one of the second preferred lateral zones extends laterally beyond the second related conveying member and laterally partially overlaps this second conveying member, and the reference lateral position is determined such that least one of the lateral edges is situated inside the related second preferred zone;
the positioning quality value Q is a function of a second cantilever coefficient CPAF2j that is a function of the cantilever of at least one of the lateral edges in relation to the related second conveying member;
the second cantilever coefficient CPAF2j is determined by a function that is monotonous inside the related second lateral preferred zone, and a second penalty modulator is applied when the concerned lateral edge is situated outside the second preferred lateral zone;
the or each conveying member defines, for each of the lateral edges, a lateral zone to be avoided that laterally partially overlaps said conveying member, which is situated laterally opposite the preferred zone of the considered conveying member, and the reference position is determined such that the two lateral edges are situated outside each lateral zone to be avoided; and the quality value Q is calculated based on the formula

$$Q = {{\sum }_{i}}^{N} Ki max ( ai 1 \cdot CPAFi 1 ; ai 2 \cdot CPAFi 2 ) + {{\sum }_{i}}^{N} max ( CPi 1 ; CPi 2 )$$

i indicating the position of the conveying device in the folding machine; N being the position of the last considered conveying device in the folding machine; K, is a value indicating the sensitivity of a signature or booklet or copy in the conveying device i. This value for example translates the fact that a copy having folds parallel to the cylinder axis from one cylinder to the next is less sensitive than one that does not: aᵢⱼ is a value indicating the stiffness of the edge j of the signature or booklet or copy in the conveying device i; and CPij is the overlap penalty coefficient of the edge j of the zone i.

The invention also provides a method for using a folding machine characterized by the following steps:
determining the reference position of the copies according to a method above;
starting the folding machine,
verifying the actual lateral position of the copies in the folding machine and, in the case where the actual lateral position of the copies differs from the lateral reference position
modifying the lateral position of the copies so as to reduce the difference between the reference lateral position and the actual lateral position.

According to one particular embodiment, this usage method includes a feature according to which a display module indicates information that corresponds to the quality value Q.

The invention also provides a folding machine comprising a device for determining the reference position of a copy, adapted to implement the method described above.

### BRIEF DESCRIPTION OF THE DRAWINGS

The invention will be better understood upon reading the description that follows, provided solely as an example, and done in reference to the appended drawings, in which:

FIG. 1 is a diagrammatic view of a folding machine according to the invention;

FIG. 2 is a view of a copy held by a first conveyor of the folding machine;

FIG. 3 is detail III of FIG. 2 on a larger scale and also shows a graph of a cantilever coefficient;

FIG. 4 is detail IV of FIG. 2 on a larger scale and also shows the graph of a penalty coefficient; and

FIG. 5 is a view similar to that of FIG. 3 of a detail of a second conveyor.

### DETAILED DESCRIPTION

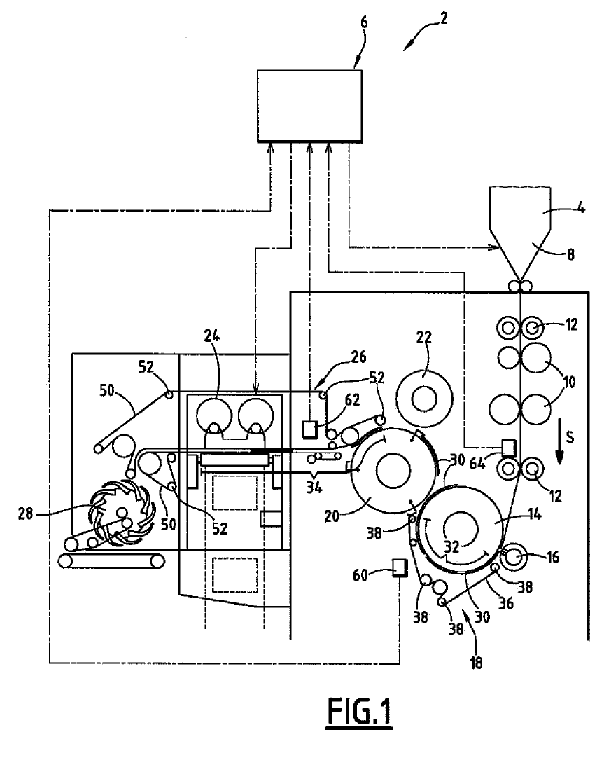

FIG. 1 shows a folding machine according to the invention, designated by general reference 2.

The folding machine 2 is adapted to fold a strip of printed paper 4.

The folding machine 2 comprises a control device 6 connected to the different components of the folding machine 2.

The folding machine 2 is provided with an input triangle 8 adapted to form a first fold in the paper strip 4.

The folding machine 2 includes four perforating cylinders 10, two of which are longitudinal perforator drums and two of which are transverse perforating discs, as well as pull rolls 12 arranged downstream from the input triangle 8. The folding machine 2 is also provided with a transfer drum 14 that cooperates with a cutting cylinder 16 adapted to cut copies 30 from the folded strip of paper 4.

A first conveyor 18 surrounds part of the circumference of the transfer drum 14.

Downstream from the transfer drum 14, the folding machine 2 also has a folding cylinder 20 as well as a second fold cylinder 22.

The folding machine 2 is also provided with a square fold device 24 and a second conveyor 26 extending from the folding cylinder 20 to a vaned rotor 28.

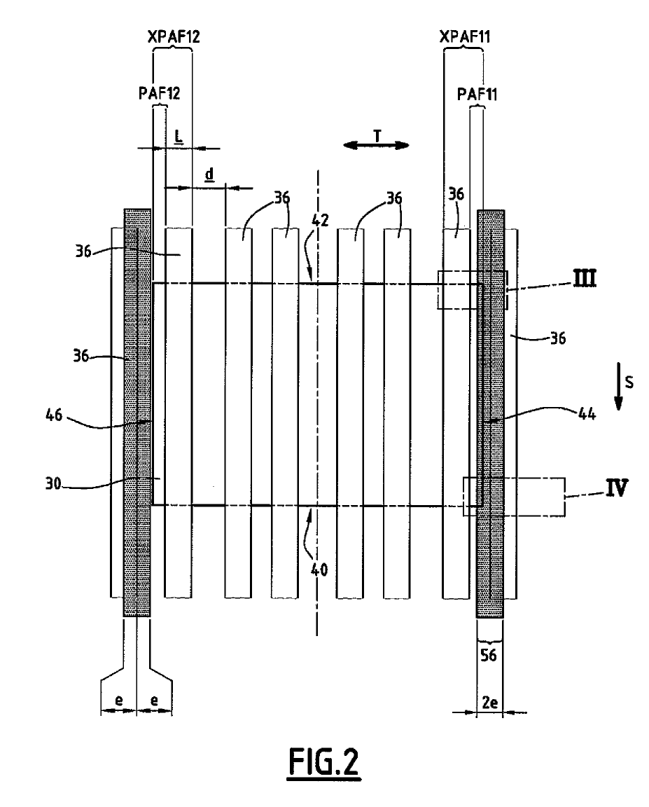

The folding machine 2 determines a path of the strip 4 and copies 30. The path of the strip 4, of the copies 30, respectively, is done in a direction of travel S that extends parallel to the plane of FIG. 1. The folding machine 2 also defines a lateral direction T extending transversely to the direction S of the path, therefore perpendicular to the plane of FIG. 1 (see FIG. 2).

The path leads from the input triangle 8 through the perforator cylinders 10 and the pull rolls 12 to the transfer drums 14 and cutting cylinders 16. These transfer drums 14 and cutting cylinders 16 separate the strip of paper 4 into copies 30. The path continues along the first conveyor 18, along part of the circumference of the folding cylinder 20 to the second conveyor 26 to the square fold device 24 or to the vaned rotor 28.

In particular, the first conveyor 18 defines a first portion 32 of the path extending around part of the circumference of the transfer drum 14. The second conveyor 26 defines a second section 34 of the path extending from the folding cylinder 20 to the square fold device 24.

The first conveyor 18 is provided with eight first conveyor belts 36 situated next to each other in the lateral direction T and guided around a plurality of guide cylinders 38. As shown in FIG. 2, each first belt 36 has a width L and a distance d to the adjacent conveyor belt 36. These sizes L and d are measured in the lateral direction T. Each belt 36 includes a middle ridge, facing the center of the copy, and a lateral ridge, facing opposite the middle ridge.

Each copy 30 defines a front edge 40 and a rear edge 42 as well as a first lateral edge 44 and a second lateral edge 46. The two lateral edges 44, 46 extend parallel to the direction of travel S.

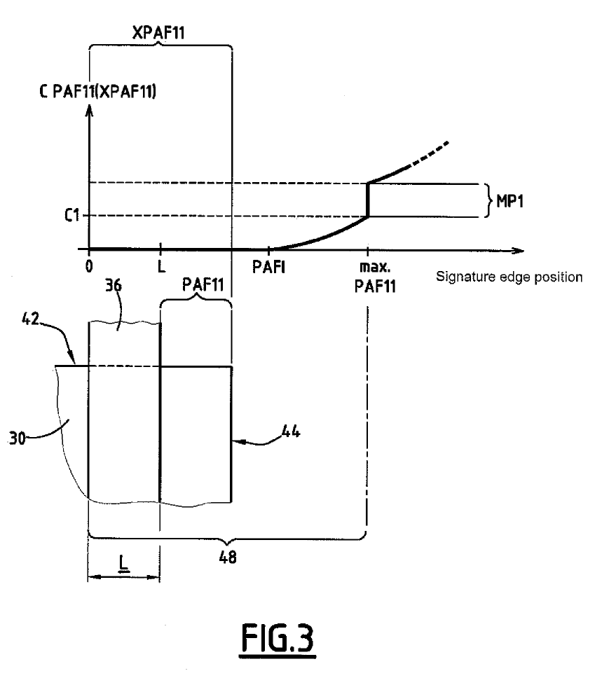

When copies 30 are conveyed by the folding machine 2, two problems may arise. The first problem is related to the cantilever PAF of a lateral edge 44, 46 in relation to the belt 36 that is in contact with the copy 30 and at the same time is last engaged with the concerned lateral edge 44, 46 (see FIG. 3). When this cantilever PAF is too great, the lateral edge 44, 46 of the copy 30 is free, the air friction then lifting the corner of the copy 30, which ends up folding it completely. This cantilever PAF must then be minimized.

The second problem leading to flaws in the copy 30 appears when the lateral edge 44, 46 of the copy 30 does not sufficiently overlap a belt 36 or is too close to a belt 36 that is not participating in the transport of that copy 30. In that case, it is the distance between the concerned lateral edge 44, 46 and the closest belt 36 that will be considered and evaluated as critical or not.

The control device 6 of the folding machine 2 according to the invention is adapted to determine a reference lateral position of the copy 30 in the folding machine so as to minimize the risks related to these two problems in one or several consecutive zones, depending on the configuration of the folding machine (and therefore depending on the desired copy type and format).

To that end, the control device 6 defines, for each of the belts 36 for each of the lateral edges 44, 46, a first preferred lateral zone 48. In FIG. 3, the first preferred lateral edge 48 of the edge 44 is shown. This first preferred lateral zone 48 extends laterally beyond the belt 36 and laterally completely overlaps said belt 36. In other words, the first preferred lateral zone 48 extends over the belt 36 and partially beyond said belt 36.

The reference lateral position of the copy 30 is determined such that in principle, the first lateral edge 44 and/or the second lateral edge 46 are situated inside the first preferred lateral zone 48 of the considered belt 36. The result is obtained by minimizing the insufficient cantilever and overlap criticality values CPAFi and CPi (see below).

The first preferred lateral zone 48 is defined from the laterally exterior side in relation to the copy 30 and in relation to the considered belt 36 by a maximum cantilever max.PAF. On the other side, the first preferred lateral zone 48 is defined by the middle ridge of the considered belt 36.

The second conveyor 26 includes eight second conveyor crowns 50 situated next to each other and guided around a plurality of guide cylinders 52. Similar to the first belts 36, each second belt 50 has a width L and a distance d to the adjacent conveyor belt 50.

These sizes L and d are also measured in the lateral direction T.

The only difference between the second conveyor 26 and the first conveyor 18 is that the second belts 50 are arranged in different lateral positions from the belts 36 of the first conveyor 18.

Moreover, in the case where the copy was folded between the first and second conveyors, the influence of the cantilever value on any degradation is reduced because the copy is stiffer. It is possible to weight the cantilever criterion for each conveyor depending on the state of the copy (folded or not, number of folds).

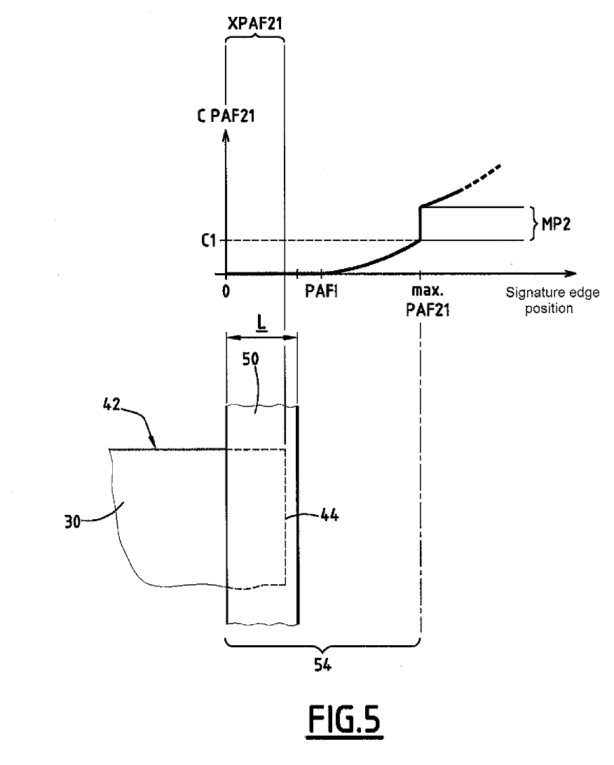

FIG. 5 shows one of the second belts 50. This belt is laterally the outermost one that supports the copy 30. It should be noted that in FIG. 5, the lateral position of the copy 30 in the folding machine is identical to that shown in FIGS. 2 and 3. Each of the two belts 50 defines, for each of the lateral edges 44, 46, a second preferred lateral zone 54. FIG. 5 shows the second preferred lateral zone 54 of the lateral edge 44. The second preferred lateral zone 54 is defined on one hand by the engagement in the second belt 50, and on the other hand by a maximal cantilever max.PAF in relation to the second considered belt 50. This maximal cantilever max.PAF of the second belt 50 has a value identical to that of the first preferred lateral zone 48, possibly with about the same factor that makes it possible to model a more significant thickness of the copy at that location due to a fold. In the calculation done, this factor can be independently configured.

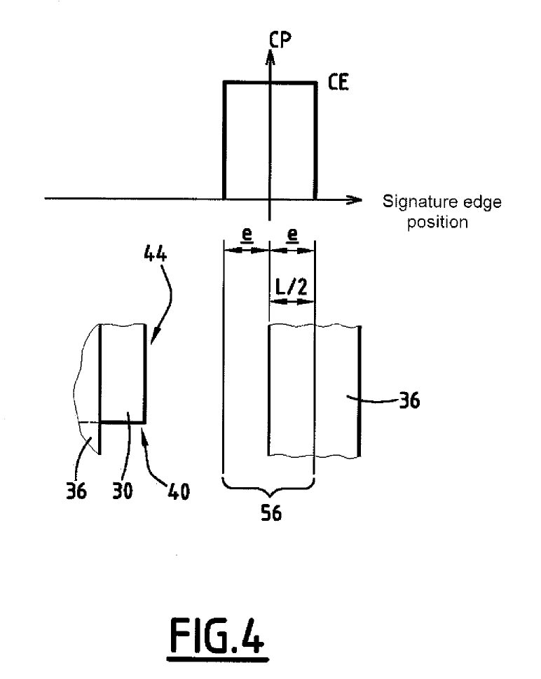

As shown in FIG. 4, each first belt 36 of the first conveyor 18 also defines, for each of the lateral edges 44, 46, a lateral zone to be avoided 56. FIG. 4 shows the lateral zone to be avoided 56 of the edge 44. This lateral zone to be avoided 56 laterally partially overlaps the belt 36 that is closest to the lateral edge 44 and does not contribute to conveying the copy 30. In this case, this zone to be avoided 56 is twice as wide e and is identical to the width of the considered belt 36. In this case, the lateral zone to be avoided 56 is made up of a portion with a width e that overlaps the belt 36 and an identical portion with a width e situated beyond the belt 36. In an alternative that is not shown, the lateral zone to be avoided 56 is made up of a portion with a width e1 that overlaps the belt 36 and a portion with a width e2 that is situated outside the belt 36, the widths e1 and e2 being different from each other.

In order to determine the lateral position of the conveyor belts, the control device 6 includes first sensors 60 that are adapted to note the lateral position and the width L of each of the first belts 36. Moreover, the control device 6 includes two sensors 62 adapted to note the lateral position and the width L of each of the two belts 50. A third sensor 64 of the control device makes it possible to indicate the actual lateral position of the strip of paper 4 or of the copies 30. Depending on the design of the folding machine, this third sensor may be upstream or down-stream from the cutting cylinder, for example in the base of “accelerated” ribbing banks, having an overspeed.

The control device 6 is adapted to determine the reference lateral position of a copy 30 such that at least one of the lateral edges 44, 46 is situated inside a first related preferred lateral zone 48. Preferably, the reference position is determined such that each of the lateral edges 44, 46 is situated inside a preferred lateral zone 48 of the first conveyor, and outside each zone to be avoided 56.

More particularly, the control device 6 determines the reference lateral position such that on each of the lateral edges 44, 46, the copy 30 is in a preferred zone 48, 54 of each of the conveyors 18, 26.

The control device 6 is adapted to move the input triangle 8 and/or the square fold device 24 laterally in relation to the direction of travel S, i.e. in the direction T. Thus, the control device 6 can move the copies 30 laterally.

In order to optimize the quality of the positioning of the copies over several zones, the control device 6 is adapted to calculate a positioning quality value Q that indicates the quality of the lateral position of the copy 30 in the folding machine.

Reference i then indicates the conveyor device. For a folding machine having N conveyor devices, this reference i can have values from 1 to N. Reference j indicates the concerned lateral edge of the copy. This reference j can have values 1 or 2. The references are noted ij.

In order to determine this positioning quality value Q, the control device 6 first determines the cantilever PAF11 of the lateral edge 44 and the cantilever PAF12 of the lateral edge 46 in relation to the first belt 36 that supports the copy and is closest to the concerned lateral edge 44, 46.

Then, a cantilever value XPAF11 is calculated based on PAF11, using formula XPAF11=PAF11+L and a cantilever value XPAF12 is calculated based on PAF12 using formula XPAF12=PAF12+L.

Generally, the value XPAFij is calculated by the sum of the cantilever PAFij and the offset between the ridge that defines the cantilever and the origin 0 of the associated function CPAF. The offset is, in this case, the width L.

In the case where the edge of the copy 30 is overlapped by the belt, the associated value PAFij remains null.

The control device 6 then determines two first cantilever coefficients CPAF11 and CPAF12, each of which is a function of one of the cantilever values XPAF11 and XPAF12.

One example of a graph of the function connecting the cantilever value XPAF11 of the lateral edge 44 to the coefficient CPAF11 is indicated in FIG. 3. In this case, the lower the risk of damaging the copy 30 for a first given cantilever PAF11, the lower the coefficient CPAF11. More specifically, when the first lateral edge 44 is situated between the edge of the associated belt 36 and an intermediate cantilever PAFI, the coefficient CPAF11 is 0. When the first cantilever PAF11 is situated between the intermediate cantilever PAFI and the maximum cantilever max.PAF11, the coefficient CPAF11 increases progressively from a value of 0 (for PAFI) to a value C1 (for max.PAF). The function CPAF11 (PAF11 or XPAF11) is therefore monotonous inside the preferred lateral zone 48. When the first lateral edge 44 crosses the maximum cantilever max.PAF11, a penalty modulator MP1 is added to the cantilever coefficient CPAF11. In the case where the first lateral edge 44 is covered by the belt 36 and inside the preferred lateral zone 48, the coefficient CPAF11 is 0. The value CPAF12 is obtained similarly, but the appearance of the graph is symmetrical to the appearance of graph CPAF11 (XPAF11).

The positioning quality value Q is also a function of the lateral position of the copy 30 in the second conveyor 26.

To that end, the control device 6 first determines the cantilever PAF21 of the lateral edge 44 and the cantilever PAF22 of the lateral edge 46 each time in relation to the second belt 50 that supports the copy 30 and is the closest to the concerned lateral edge 44, 46.

Then, a cantilever value XPAF21 is calculated based on PAF21, using formula XPAF21=PAF21+L and a cantilever value XPAF22 is calculated using formula XPAF22=PAF22+L.

Then, two second cantilever coefficients CPAF21 and CPAF 22 are determined, each of which is a function of one of the cantilever values XPAF21 and XPAF22.

FIG. 5 shows an example of a graph connecting the cantilever value XPAF21 to the cantilever coefficient CPAF21. As shown in FIG. 5, the appearance of the graph of the coefficient CPAF21 (PAF21 or XPAF21) is identical to the appearance of the graph of the coefficient CPAF11 (PAF11), but is laterally staggered by a value corresponding to the lateral offset between the first belts 36 and the second belts 50.

The positioning quality value Q also depends on whether the lateral edges 44, 46 are situated in a zone to be avoided 56.

In the case where the considered edge 44 or 46 is situated in a zone to be avoided 56, the control device 6 applies at penalty coefficient CP equal to a value CE. In the other cases, the penalty coefficient CP is set at 0.

Then, the positioning quality value Q is calculated by the control device 6 as a function of coefficients CPAF11, CPAF12, CPAF21 and CPAF22 and the penalty coefficients. Thus, one obtains a positioning quality value indicating the overall risk of damage to the copy by the conveyors 18 and 26. For example, the lateral positioning quality value Q for the two conveyors 18; 26 can be equal to Q=K1×[MAX ((a11×CPAF11); (a12×CPAF12))]+K2×[MAX ((a21×CPAF21); (a12×CPAF22))]+MAX (CP11; CP12)+MAX (CP21; CP 22)

i being 1 for the first conveyor 18 and 2 for the second conveyor 26;

Ki is a value indicating the sensitivity of the signature or booklet or copy in the conveyor i. This value Ki translates the fact that a copy having folds parallel to the cylinder is less sensitive than when it does not have one.

aij is a value indicating the stiffness of the lateral edge j of the signature or booklet or copy in the conveyor i. This value aij represents the fact that the edge of the copy having a triangle fold is stiffer than the free edge.

CPij is the penalty coefficient representing the overlap criticality of the edge j in the conveyor i.

The control device 6 then calculates the positioning quality value Q for at least two different lateral positions of the copy 30 in the folding machine 2, and then determines, as reference lateral position, the position for which the quality value Q is that for which the risk of damage to the copy is the smallest. In this case, the reference lateral position is that whereof the positioning quality value Q is the smallest.

In order to further improve the folding quality during the operation of the folding machine 2, the control device 6 notes, via the sensor 64, the actual lateral position of the strip 4 and of the copies 30 and compares said actual lateral position with the reference lateral position. In the event the actual lateral position differs from the reference lateral position, the control device 6 moves the triangle 8 and/or the square fold device 24 so as to reduce the difference between the reference lateral position and the actual lateral position. This movement is preferably done until the actual lateral position is identical to the reference lateral position.

It should be noted that the method for determining the reference lateral position according to the invention was described in the case of the specific example of the first conveyor 18 and the second conveyor 26. The method can be applied in the same way to a folding machine having a number N of successive conveying devices on a given path. In this case, the control device 6 calculates 2×N cantilever coefficients CPAP11 and 2 . . . CPAFn1 and 2 and the value Q is a function of the maximum per zone of these 2×N coefficients.

In its most general form, the formula for calculating the value Q can be:

$${{\sum }_{i}}^{N} Ki max ( ai 1 \cdot CPAFi 1 ; ai 2 \cdot CPAFi 2 ) + {{\sum }_{i}}^{N} max ( CPi 1 ; CPi 2 )$$

i indicating the position of the conveying device (conveyor) in the folding machine; N being the position of the last considered conveying device in the folding machine; Ki is a value indicating the sensitivity of a signature or booklet or copy 30 in the conveying device I; aij is a value indicating the stiffness of the edge j of the signature or booklet or copy in the conveying device I (this value represents the fact that the copy edge having a triangle fold is stiffer than the free edge); and CPij is the overlap penalty coefficient of the edge j of the zone i).

The method for determining the reference lateral position is also not limited to conveyors, but can be applied to any conveying device including conveying members, such as belts, bands, clips or gripping fingers.

The method according to the invention makes it possible to minimize the risks of damage to copies by the various conveying devices.

Alternatively, it is not necessary to calculate a cantilever value XPAFij to determine the coefficient CPAFij, but this coefficient CPAFij can depend solely on PAFij.

The folding machine according to the invention can advantageously include a display module that is adapted to indicate information corresponding to the quality value Q.

1-14. (canceled)

15. A method for determining a reference lateral position of a copy in a folding machine, the copy having a given width and being defined by first and second lateral edges, the folding machine being designed to convey the copy in a path and having at least two first conveying members that convey the copy over a first portion of the path, each first conveying member defining, for each of the first and second lateral edges, a first preferred lateral zone, the method comprising:
defining at least one of the first preferred lateral zones as extending laterally beyond the at least one of the first conveying members and laterally overlapping the respective first conveying member; and
determining a reference lateral position such that at least the first lateral edge is situated inside the first preferred lateral zone of the first lateral edge.

16. The method according to claim 15 wherein the reference lateral position is determined such that the second lateral edge is situated inside the first preferred lateral zone of the second lateral edge.

17. The method according to claim 15 wherein at least one of the first preferred lateral zones is defined by a maximum lateral cantilever of the respective lateral edge in relation to the respective first conveying member.

18. The method according to claim 15 wherein a positioning quality value Q is calculated for at least two lateral positions of the copy in the folding machine, the positioning quality value Q indicating the risk of damage to the copy, the positioning quality value Q depending on the position of the first and second lateral edges in relation to the preferred lateral zones, the reference lateral position being whereof the quality value Q corresponds to the smallest risk of damage among the calculated positioning quality values Q.

19. The method according to claim 18 wherein the positioning quality value Q is a function of a first cantilever coefficient that is a function of a cantilever of at least one of the lateral edges in relation to the respective first conveying member.

20. The method according to claim 19 wherein the first cantilever coefficient is determined by a function that is monotonous inside the first related preferred lateral zone, a first penalty modulator being added to the first cantilever coefficient when the concerned lateral edge is situated outside the preferred lateral zone.

21. The method according to claim 20 wherein the folding machine includes at least two conveying members for conveying the copy onto a second portion of the path, each second conveying member defining, for each of the lateral edges, a second preferred lateral zone, at least one of the second preferred lateral zones extending laterally outside the respective second conveying member and laterally partially overlapping the respective second conveying member, the reference lateral position being determined such that least one of the lateral edges is situated inside the related second preferred lateral zone.

22. The method according to claim 21 wherein the positioning quality value Q is a function of a second cantilever coefficient that is a function of a cantilever of at least one of the lateral edges in relation to the respective second conveying member.

23. The method according to claim 22 wherein the second cantilever coefficient is determined by a function that is monotonous inside the related second preferred lateral zone, a second penalty modulator being applied when the concerned lateral edge is situated outside the second preferred lateral zone.

24. The method according to claim 15 wherein at least one of the conveying members defines, for each of the lateral edges, a lateral zone to be avoided that laterally partially overlaps the respective conveying member, the lateral zone to be avoided being situated laterally opposite the preferred lateral zone of the respective conveying member, the reference position being determined such that the two lateral edges are situated outside each lateral zone to be avoided.

25. The method according to claim 18 wherein the quality value Q is calculated based on the formula
$$Q = {{\sum }_{i}}^{N} Ki max ( ai 1 \cdot CPAFi 1 ; ai 2 \cdot CPAFi 2 ) + {{\sum }_{i}}^{N} max ( CPi 1 ; CPi 2 )$$
indicating the position of a conveying device in the folding machine;
N being the position of a last considered conveying device in the folding machine;
Kᵢ being a value indicating the sensitivity of a signature in the conveying device i;
aᵢⱼ being a value indicating the stiffness of the edge j of the signature in the conveying device i; and
CPij being the overlap penalty coefficient of the edge j of the zone i.

26. The according to claim 25 wherein Kᵢ is a value that expresses a copy having folds parallel to the cylinder axis from one cylinder to the next is less sensitive than a copy that does not have folds parallel to the cylinder axis from one cylinder to the next.

27. A method for using a folding machine comprising:
determining the reference position of the copies according to the method recited in claim 15;
starting the folding machine;
verifying the actual lateral position of the copies in the folding machine and, in the case where the actual lateral position of the copies differs from the lateral reference position; and
modifying the lateral position of the copies so as to reduce the difference between the reference lateral position and the actual lateral position.

28. The method according to claim 27 wherein a positioning quality value Q is calculated for at least two lateral positions of the copy in the folding machine, the positioning quality value Q indicating the risk of damage to the copy, the positioning quality value Q depending on the position of the first and second lateral edges in relation to the preferred lateral edges, the reference lateral position being whereof the quality value Q corresponds to the smallest risk of damage among the calculated positioning quality values Q, wherein a display module indicates information that corresponds to the quality value Q.

29. A folding machine comprising:
at least one conveying device for conveying a copy in a path, the copy having a given width and being defined by first and second lateral edges, the conveying device having at least two first conveying members that convey the copy over a first portion of the path, each first conveying member defining, for each of the first and second lateral edges, a first preferred lateral zone, at least one of the first preferred lateral zones as extending laterally beyond the first connected conveying member and laterally overlapping the first conveying member; and
a device for determining a reference lateral position such that at least the first lateral edge is situated inside the first preferred lateral zone of the first lateral edge.
